(19) United States
(12) Patent Application Publication
(10) Pub. No.: US 2010/0310893 A1
(43) Pub. Date: Dec. 9, 2010

(54) ENGINEERED WOOD PRODUCT

(75) Inventors: Daniel B. Derbyshire, Cary, NC (US); Joy K. Nunn, Bixby, OK (US); Bradley R. Tate,Nunn, Glenpool, OK (US); Susan Hughes, Wagoner, OK (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignees: Mallard Creek Polymers, Inc., Charlotte, NC (US); Sustainable Solutions, Inc., Wagoner, OK (US)

(21) Appl. No.: 12/445,609

(22) PCT Filed: Nov. 1, 2007
(86) PCT No.: PCT/US07/23093

§ 371 Date: Aug. 24, 2010

Related U.S. Application Data
(60) Provisional application No. 60/856,221, filed on Nov. 1, 2006.

(51) Int. Cl. C08L 97/02; B32B 21/08; B32B 21/04; B29C 43/24; B32B 38/00

(52) U.S. Cl. 428/528; 524/13; 428/535; 264/175; 156/242; 264/328.1

(57) ABSTRACT

Engineered wood products, methods of making the products, laminates including the products, and articles of manufacture which include the engineered products or composites, are disclosed. The products include wood and/or other cellulosic fibers, and can include non-cellulosic fibers, all or part of which can be derived from post-industrial and/or post-consumer materials. The products also include a binding agent, such as a latex dispersion, as well as hydrophobic materials, processing aids, colorants, and the like. The product can be in the form of a sheet, a three dimensional article or a plurality of laminated sheets, and can include one or more additional layers, such as top coat layers, reinforcing layers, cushioning layers, wood veneer layers, and/or additional product layers. The products can be used as flooring, and in construction, cabinetry, and the like.

This application claims benefit of U.S. provisional application No. 60/856221, filed on Nov. 1, 2006.

### FIELD OF THE INVENTION

The following invention is generally in the field of composite materials, and is more specifically directed to composite materials including wood or other cellulosic fibers and a binding agent, which for the purpose of this application will be referred to as an engineered wood product.

### BACKGROUND OF THE INVENTION

A variety of consumer goods are prepared from wood, including plywood, oriented strand board (OSB), glued-up laminates (glue-lams), I-beams, particle board, chip board, flooring, paneling, and the like. During manufacture of wood products, a certain amount of post-industrial waste is produced, as the wood is cut to shape. There is also a certain amount of post-consumer waste generated when wood, for example, in the form of used pallets, is discarded.

There are conventional methods for recycling post-industrial wood scraps, which typically include grinding up the scrap and using it as a component in various end items, such as oriented strand board and particle board. Typically, the ground wood scraps are mixed with and/or coated with various synthetic materials, such as plastics, and used in various products. A major limitation of these products, such as oriented strand board and, particularly, particle board, is that they are extremely likely to warp and/or break down when exposed to excess moisture.

It would be desirable to have products with a high percentage of wood or other cellulosic fibers, which are moisture resistant. It would further be advantageous to provide compositions and methods for using post-industrial and/or post-consumer wood and/or other cellulosic waste to replace wood, oriented strand board, particle board, and the like, with a less hydrophilic product. The present invention provides such compositions and methods.

### SUMMARY OF THE INVENTION

The present invention is directed to an engineered wood product, methods of making the product, composite materials including the engineered wood product, and articles of manufacture which include the engineered wood product and/or composite materials.

The material includes wood and/or other cellulosic fibers, which can be post-industrial or post-consumer materials, which are ground up, optionally refined, and bound using a binder such as a latex composition.

The wood used to form the engineered wood product can be in the form of fibers, dust, particles, shavings, wood flour, wood chips, and the like, and generally falls in the size range of between about 0.1 microns and 50 mm, ideally between about 0.1 mm and 6 mm. The term “wood fiber” is used herein to describe all of these embodiments. In some embodiments, the wood is derived from post-industrial and/or post-consumer materials.

Representative non-wood cellulosic fibers include those derived from cotton, wool, jute, kenaf, hemp, fibers that are mechanically generated from organic materials such as leather, and/or other cellulose staple fibers.

Scrap fibers (fibers other than wood or other cellulosic materials) can also be present in the material. These can be natural or synthetic, organic or inorganic, or blends thereof. Examples of organic fibers include, but are not limited to, polyamides, polyester, polyolefins, polyurethanes and the like. Examples of inorganic fibers include but are not limited to mineral wool, glass fibers and the like.

The amount of wood and/or other cellulosic fibers in the engineered wood product is typically between around 10 and around 90% by weight, preferably between around 35 and around 80% by weight, and, more preferably at least around 51% by weight of the overall product composition. The amount of scrap fibers in the engineered wood product is typically between around 0 to around 49% by weight, more typically, between around 5 and around 40% by weight of the overall product composition.

The engineered wood product also includes a sufficient amount of a binder (also referred to as a binding agent), such as a latex composition, to bind the fibers. The binding agents can be synthetic or natural. Representative binding agents include synthetic latex, natural latex, polyvinyl alcohol (PVA), polymeric dispersions and starch.

Examples of suitable latex compositions include those prepared by emulsion polymerizationof various monomers.

Thermosetting materials that can be used include, but are not limited to, epoxies, phenolics, bismaleimides, polyimides, melamines, melamine/formaldehyde resins, polyesters, urethanes, urea, and urea/formaldehyde resins. These are also referred to herein as crosslinking agents.

Other components can optionally be present. Representative additional components include hydrophobic agents, processing aids, and colorants. The hydrophobic agents can impart advantageous properties to the engineered wood product, for example, water-resistance higher than conventional engineered wood products such as chipboard, particle board, oriented strand board, and the like. Representative hydrophobic agents include oils, silicones, waxes, calcium stearate, and the like. Representative processing aids include retention aids, flocculants, and the like. The composition can also include inorganic fillers, such as calcium carbonate, clays, pigments such as titanium oxide, carbon black, and inorganic or organic pigments.

The engineered wood product is typically formed by combining the fibers with an aqueous dispersion of a binder, such as a latex, to form a fiber furnish, which is then calendared to remove the water. When heated under pressure, using techniques similar to those used in the paper-making arts, the fibers can be formed into sheets.

The sheets can be laminated together if desired by application of heat and/or pressure. In some embodiments, the engineered wood product is formed by pelletizing the calendered material, and then forming, extruding, or injection molding the material into useful products/parts. In other embodiments, the engineered wood product can be thermally and/or vacuum molded into desired end-products.

A composite material can be formed that includes one or more sheets of the engineered wood product, and one or more additional layers. Representative additional layers include top coat layers, reinforcing layers, cushioning layers, veneer layers, melamine layers, sound deadening layers, graphic layers and wear layers.

The engineered wood product can be coated for numerous reasons, depending on the end use application. Suitable coating layers include, but are not limited to, acrylic and/or polyurethane layers, veneer layers, melamine layers, paint layers, graphic layers, and metal oxide layers.

The engineered wood product can contain a reinforcing material bound to the substrate, or embodied within the substrate, to provide added strength and/or other properties. This can be done during the wet-lay process or post-processing through the use of adhesives that are water based, 100% solids, UV and moisture cure, hot melt, solvent based and the like. Representative reinforcing materials include fibers, scrims, woven and non-woven materials, films, metal meshes or sheets, and the like.

Clear or color coats can be used, and a primer coat can be present between the substrate and the topcoat layer. The layers can be dyed or printed to provide the composite material with a variety of designs including, but not limited to, geometrics, animal prints, floral designs, and the like, for reasons of aesthetics, functionality, or other end use requirements.

The engineered wood product also advantageously provides desirable acoustical properties, for example, sound insulation, absorption, reflection, and deflection, when used as a replacement for medium density fiberboard (MDF) in speaker boxes or floor underlayment.

The engineered wood product and/or the composite material formed from this product can be used in virtually all applications for which wood, particle board, chipboard, and oriented strand board are used. Examples include, but are not limited to, wood seats, car interiors, furniture, laminate countertops, cabinetry (particularly when covered with a veneer layer of a desired wood), I-beams, glue-lams, flooring, underlayments, sheething and the like.

### BRIEF DESCRIPTION OF THE FIGURES

FIG. 1 is a schematic illustration of a fine pulp molding process used to form a shaped article in accordance with the present invention.

FIG. 2 is a schematic illustration of an alternative embodiment of the method shown in FIG. 1.

FIG. 3 is a schematic illustration of a paper-making process used to form a shaped article in accordance with the present invention.

FIG. 4 is a schematic illustration of an alternative embodiment of the method shown in FIG. 3.

### DETAILED DESCRIPTION

The present invention will be better understood with reference to the following detailed description. The various components of the engineered wood product, and composite materials, including the substrate and topcoat layers, reinforcing layers, cushioning layers, and/or adhesives, are discussed in detail below.

The resulting engineered wood product and resulting composites are unique materials. Examples of the uniqueness of the materials include, but are not limited to, the fact that the material is more hydrophobic than traditional wood, there are manufacturing efficiencies (utilizing existing equipment with reduced waste), and the materials provide flexibility of design for multiple end-use applications, since the wood products can be formed in any desired shape. In certain embodiments, the engineered wood product and resulting composite can provide strategic acoustic properties, improved hardness, and improved hydrophobicity. In some embodiments, the density ranges from between about 20 to about 120 pounds/cubic foot.

The original manufacturer of the wood used to form the composite material can obtain a cost benefit, because landfill and/or incineration costs are reduced. The manufacturer of the engineered wood product and resulting composites also obtains a cost benefit because the material cost is reduced, and the engineered wood product can be used in a finished three-dimensional part or application.

### I. Components

The engineered wood product includes wood, non-wood fibers, and a binding agent. In addition, the substrate includes one or more additional components. Examples of these components are described in more detail below.

Wood

The wood can be from virtually any source of wood, including trees (ideally, salvage timber), post-industrial materials such as sawdust, wood scraps, fibers, dust, particles, shavings, wood flour, wood chips, and the like, including wood derived from used pallets, unbleached wood pulp, and post-consumer materials. In some embodiments, engineered wood materials and regenerated wood material can also be used.

The particle size of the wood is generally in the range of about 0.1 microns to 50 millimeters overall, ideally between about 0.1 mm and about 6 mm, and less than about 25 millimeters. The particles typically have a length of from 0.1 mm-6 mm, but fine particles can also be used. The particles need not be of a constant diameter. They can be flattened/layered to achieve substantially constant thickness (i.e., no more than about 25% variance in thickness).

If the source of the wood fibers is known, it is possible to track these fibers through the process to the composite material and products formed from the composite material. As a result, it is possible to trace the fibers in the end product back to their source.

It has been found that suitable cellulosic material may be derived from post industrial/consumer wood such as wood pallets, and particularly wood pallets that are broken or have exceeded their useful life. Wood derived from such pallets or other suitable source is ground to a size of approximately 1.5-2 inches and then further refined to its constituent cellulosic fibers. The resultant cellulosic material may then be stored or transported for further processing according to the present invention.

Non-Wood Fibers

In addition to the wood, the composition also includes additional fibers (“non-wood fibers”). When the composite wood material does not include such other fibers, the resulting material may not be optimal. One purpose of these other fibers is to provide strength, binding, processability, fire retardancy, aesthetics and/or improved insulation properties to the composite material. Like the binding agents, these fibers are an integral part of a wet process for making sheet goods.

The non-wood fibers can be organic and/or inorganic, natural and/or synthetic, and can be derived from post-industrial, virgin, and/or post-consumer fibrous materials. Representative examples include cellulosic materials, polymeric materials, and glass-like materials. The other fibers are typically in the range of greater than 0 and about 49% by weight of the product, preferably between about 5 and about 40% by weight of the product.

Cellulosic Fibers

In one embodiment, the other fibers are post-industrial regenerated natural fibers which include, but are not limited to, cotton, kenaf, hemp, bagasse, bamboo, palm, jute, and bleached wood fibers found in wood pulp or paper. In one aspect of this embodiment, these fibers are present in place of the wood fibers.

The fibers can also be derived from other natural materials, such as wool, leather, and silk. Due to the large amount of cotton used in industrial textile processing in the apparel, carpet, furniture, and household goods industries, a significant amount of post-industrial cotton is available as a waste stream, and, accordingly, is a relatively inexpensive material. Opened, cut, and refined cellulose and cotton fiber can act to strengthen or soften the substrate. Certain natural fibers may require refining before blending with the wood. Processes are available and known in the industry for cutting and opening the scrap raw material to produce component fibers.

Synthetic Fibers

In other embodiments, the fibers can be derived from synthetic polymeric materials, and can be derived from scrap materials (i.e., scrap fibers). The scrap fibers can include low melting point (i.e., below around 175° C.) synthetic fibers and high melting point (i.e., above around 175° C.) synthetic fibers. Examples of low melting point synthetic fibers include, but are not limited to, polyolefins such as polyethylene and polypropylene, and low melting point polyesters. Bi-component fibers can also be used. Examples of high melting point fibers include nylon, high melting point polyesters, polystyrene, styrene copolymers such as styrene acrylonitrile (SAN), polyphenylene ether, polyphenylene oxide (PPO), poletheretherketone (PEEK), polyetherimide, polyphenylene sulfide (PPS), poly(vinylacetate) (PVA), poly(methylmethacrylate) (PMMA), poly(methacrylate) (PMA), ethylene acrylic acid copolymer, and polysulfone. Additional materials include acrylics, polyamides, polyethers, rayon, and aramids.

It should be understood that these lists of fibers are not exhaustive, and not limiting with regard to fibers that could be considered high or low melting point synthetic fibers for the purpose of the present invention.

In addition to the organic polymeric materials, inorganic materials such as fiberglass and mineral wool can also be used, in place of, or in addition to, the polymeric fibers.

Depending on the characteristics of the desired application, the fibers range in size from nano to coarse deniers and lengths from 0.1 micron to 1 inch. These fibers most typically come from post-industrial sources as well.

Certain of these fibers can provide fire retardancy, moisture management, aesthetics, strength, and the like. Higher amounts of specific “non-wood fibers” may increase the stiffness, strength, or other properties of the composite materials. The properties can be ascertained using standard ASTM, FLTM, SAE, or other assays. Representative assays include, for example, ASTM D1039 (Standard Test methods for Evaluating Properties of Wood Based Fiber and Particle Panel Materials). One of skill in the art can readily select an appropriate amount of a certain other fiber based on desired properties for a given end-use for the composite wood material. Using the assay described above, one can readily ascertain whether the engineered wood product and/or composite materials including the substrate have various desired properties.

Representative synthetic materials include polyester, nylon, acrylics, polyamides, polyolefins such as polyethylene and polypropylene, polyethers, and the like. Due to the large amount of synthetics used in industrial processing of textiles, a significant amount of post-industrial synthetic material is available as a waste stream, and, accordingly, is a relatively inexpensive material. The addition of these fibers can contribute to other unique characteristics of the composite material. These characteristics are ideally measured by ASTM or other assay standards described herein, which vary depending on the end-use of the product. The amount of the other fibers varies depending on the unique characteristics of the product required to achieve the desired properties of the end-product including the engineered wood product.

Fiber Refining Techniques

A conventional process for cutting and opening scrap textile fibers as a source for the cellulosic component or for the scrap component is preferably obtained from the post-industrial waste stream. Since textile scrap is typically obtained from the producer/manufacturer, the component fibers of the textile scrap are known. The post-industrial scrap material may include synthetic, natural, and/or cellulosic fibers.

In one embodiment, the post-industrial scrap is first conveyed to a scrap cutting station, where the scrap material is cut into small pieces. From there, the cut scrap is conveyed to an opening line where a series of rotary cutters or roatary pins successively pull apart the fabric until it is reduced to its constituent fibers.

From the opening line, the opened fibers from the post-industrial scrap are conveyed to a baling apparatus. Once cut and opened, the reclaimed industrial scrap fibers can be baled for further processing.

The fibers which result from a conventional opening process are commonly stretched, twisted, and distorted, which may result in weakening of the fibers. In addition, although an attempt is made to produce uniform fiber lengths, such attempts are relative and are generally within a range with an attempted average fiber length. Conventional cutting and opening processes also produce fibers which are frayed and include an end structure which is not cleanly cut, resulting in pulled or trailing ends. With regard to synthetic fibers, as the cutting blades heat up as a result of friction, and begin to become dull, the synthetic fiber ends tend to melt and/or fuse with adjacent fibers. All of these non-uniformities (damage) cause difficulty in processing the reclaimed fibers into useable and/or commercial products. Moreover, conventional opening processes have been found unsuitable for opening tightly woven fabrics such as cotton textiles.

A proprietary process for opening and cutting fibers from post-industrial scrap has been developed by Sustainable Solutions, Inc., Tulsa, Okla. By way of this process, opened and cut fibers can be obtained which are traceable to the originator of the post-industrial scrap as may be or become necessary as a result of legislation. When such traceable fibers are obtained, they are highly suited for use in the present process, so that they can be traced through to the resultant composite web and thereon for further processing. In this way, the reclaimed fibers in the recycling stream are traceable to their origins.

If traceable fibers are obtained, those fibers can be tracked through the present process to the resultant composite web and products made therefrom. In this way, these fibers can be traced back to their source.

In the present process, according to the above, cellulosic (wood) material or opened and cut cellulosic fibers from post-industrial scrap are obtained. The cellulosic material is then mixed with an encapsulating agent such as an aqueous latex dispersion to form a fiber furnish.

In the event that the cellulosic material is derived from textile scrap, such as cotton, for example, the scrap can first be refined before mixing with the binder in the fiber furnish. Cotton is conventionally designed to be tightly woven, to produce a tough and durable fabric. As a result, cotton textile fabrics are difficult to open. However, due to their abundance, opened fibers derived from post-industrial cotton scrap are highly suited for the natural component of the process described herein. With regard to the present invention, the term “refining” shall mean to perform a freeness reduction on the natural fibers and cellulosic fibers in the fiber furnish.

The refining process preferably includes a conventional technique for hydrating the cellulosic fibers using a disk refiner equipped with bars in a water solution, however, other refining methods are contemplated in this process. Although hydration in a chemical sense does not occur, the affinity for water of the fiber matrix is enhanced. Refining the fiber causes the natural fibers, and particularly the cellulosic component fibers to swell (take on water, bend, and fibrillate. The swelling and fibrillation enhances the number of interfiber contacts during formation of the intermediate web. The outer surfaces of the fibers become more slippery, such that the tendency to form fiber flocs (bundles of fiber) is reduced. The refined fibers form hydrogen bonds which join them upon drying. Refining greatly increases the wet specific surface of the natural fibers, the swollen specific volume, and the fiber flexibility. The result is a fiber furnish that includes cellulosic fibers which are tangled and suitably prepared for encapsulation. Refining also significantly increases the quality of the fibers to bond when dried from the fiber furnish to form the engineered wood product described herein. A freeness reduction (Canadian standard) of the natural fibers from approximately 700° CSF down to approximately 200° CSF is preferred in the present process.

Fillers

In many applications, inorganic fillers are an integral part of the formulation. The fillers help to minimize the overall cost of the formulations, and provide other functions as well. The other functions include reinforcement, abrasion resistance, fire retardancy, noise reduction, heat resistance, barrier properties, porosity, efficiency in processing, and the like. The fillers can also provide smoothness to the sheet, therefore making it easier to emboss and, therefore, more aesthetically pleasing. They can also alter the porosity. The fillers are typically present in a weight range of from about 0 to about 80 percent, for example, about 0.5 to about 60 percent, and typically about 5 to about 25 percent.

Various “low density materials,” include ceramics, pearlite, and other non-elastomerics such as glass microbubbles, can be used as low density fillers to produce relatively lightweight structural materials. The particles can have any shape, including spherical, plate-like, non-uniform, and the like. These particles are particularly useful in embodiments where a relatively lighter weight is desired.

By way of example, suitable fillers include calcium carbonate (precipitated, ground limestone, whiting, etc.), barium carbonate, magnesium carbonate, and other metal carbonates, calcium fluoride, sodium aluminum fluoride, aluminum hydroxide, aluminum, bronze, lead, zinc, aluminum oxide, aluminum trihydrate, calcium oxide (cement), magnesium oxide, silicon dioxide (silica: colloidal sol, diatomaceous, novaculite, pyrogenic, quartz flour, vitreous, wet process), pigments, such as titanium dioxide, zinc oxide, and carbon black, clays/silicates (kaolin clay, montmorillonite clay, hectorite clay, calcined kaolin, calcium silicate, feldspar, glass tripolite, mica, muscovite, phlogopite, vermiculite, nephiline, pyrophyllite, perlite, talc, wollastonite), barium sulfate (barite, blanc fixe), calcium sulfate (gypsum, anhydrite, precipitated), lithopone, zinc sulfide, sodium aluminosilicate, ground cork, ground corn cob, shell flour, ground sulfur-chlorinated vegetable oil, ground vulcanized vegetable oil, polystyrene, phenol-formaldehyde resin, mineral rubber, and other ground polymeric resins, ceramic and zirconia microspheres, particulate forms of the 2^{nd} regeneration wood composite described herein, and the like. As used herein, a 2^{nd} regeneration wood composite is formed from the engineered wood product described herein, for example from waste material left over from end-use applications, which is converted to a filler for re-use. As such, the filler formed from the 2^{nd} generation wood composite includes wood, non-wood fibers, binder, and other various components as described herein.

The particles used can have a variety of shapes. They can range, for example, from non-spherical and/or non-uniform, to predominantly spherical, with a uniform shape. They can have a variable aspect ratio, and can be present in a relatively broad size distribution.

Certain of the fillers include functional groups (i.e., functionalized fillers), and/or functional surfaces. These functional groups can permit subsequent chemical bonds to be formed, and can provide for various physical and chemical properties. For example, the surface of a filler can be made hydrophobic, fire retardant, and the like. Examples of suitable functional groups include halo, such as fluoro, hydroxyl, amine, thiol, carboxylic acid, sulfonic acid, amide, olefin, and the like.

Binding Agents

Binding agents help to bind the fillers, fibers and other ingredients in the formulation, and to provide strength and durability. The binding agents can provide an adhesive bond between the wood component and the other fibers, and can also provide structural and/or other characteristics, such as water resistance, to the composite and resulting products that include the composite. The binding agents include anionic, cationic, and non-ionic binders and are typically present in about 3 to about 50%, for example, between about 8 and about 30% by weight, on a thy weight basis.

Examples of suitable binders/binding agents include latex materials, which can be prepared by emulsion polymerization of various monomers. The binders can also be dispersions such as polyurethane, epoxy, polyethylene, and polyethylene terephthalate. Preferred binders include acrylic, styrene acrylic, styrene butadiene, nitrile, and nitrile butadiene latexes.

The latex compositions can be optimized to promote adhesion to hydrophobic synthetic fibers (i.e., the scrap fibers). The range of commercially available chemical modifications to latex compositions is large, and designed to meet almost any desired characteristic of the composite web or end use requirements of the product manufactured therefrom.

The latex compositions can range from hard rigid types to those which are soft and pliable (rubbery). Moreover, these latex compositions can either be thermoplastic or thermosetting in nature. In the case of thermoplastic latex, the latex may or may not be a material which remains permanently thermoplastic. The latex binding agents used in the present process may include non-crosslinked latex, which is preferred. Alternatively, such binding agents may be of a type which is partially or fully cross-linkable, with or without an external catalyst, into a thermosetting type binder. Listed below are several examples of suitable latex compositions for use in the present process. It should be understood that the present invention is not limited to the specific examples listed in the categories defined below as suitable monomers for producing the latex.

Representative polymers in the polymer latex compositions include, without limitation, acrylates, vinyl-acrylic acid copolymers, styrene-acrylic copolymers, vinyl acetate-ethylene copolymers, vinyl ester copolymers, polystyrene, styrene/acrylate copolymers, polybutadiene, polyacrylonitrile, styrene/butadiene copolymers, styrene/acrylonitrile copolymers, butadiene/acrylonitrile copolymers, styrene/butadiene/acrylonitrile terpolymers, polyvinyl alcohol, ethylene/vinyl alcohol copolymers, polyvinyl acetate, ethylene/vinyl acetate copolymers, ethylene/vinyl chloride copolymers, poly(meth)acrylic acid, poly(meth)acrylates, vinyl acetate/acrylate copolymers, halogenated polymers and copolymers, such as polyvinyl chloride, polyvinyl dichloride, polyvinylidine chloride, and neoprene (chloroprene), ethylene/acrylic acid copolymers, polyethylene/urethanes, polycarbonate, polyphenylene oxide, polypropylene, polyesters, polyamides, and combinations of these (including the combinations outlined above).

Latex binders, when used, can contain functionality. Any kind of latex can be used, although acrylics may be preferred because they tend to provide good heat and light stability. Representative acrylics include those formed from ethyl acrylate, butyl acrylate methyl (meth)acrylate, carboxylated versions thereof, glycidylated versions thereof, self-crosslinking versions thereof (for example, those including N-methylol acrylamide), and copolymers and blends thereof, including copolymers with other monomers such as acrylonitrile. Natural polymers such as starch, natural rubber latex, dextrin, cellulosic polymers, and the like can also be used.

In addition, other synthetic polymers, such as epoxies, urethanes, phenolics, neoprene, butyl rubber, polyolefins, polyamides, polyesters, polyvinylalcohol, and polyesteramides can also be used.

In certain embodiments, it can be preferred that these binders are hydrophobic, to impart hydrophobicity to the resulting material.

One or more of the monomers can be carboxylated or otherwise functionalized with reactive groups to enhance the physical and chemical properties of the resulting latex compositions. Chemical modifiers can also be added. Examples of such modifiers include chelating agents, antioxidants, thickeners, protective colloids, surfactants (for example, to improve the stability, wetting, and penetration), water-miscible organic solvents, for example, added as temporary plasticizers, defoaming agents, or humectants, water-soluble salts, acids, and bases to adjust the pH, alter flow properties, and/or stabilize the latex polymer against heat and light breakdown.

Processing Aids

The type of processing aid, and whether a processing is needed, depends on the nature of the binder. If a cationic polymer is used, an anionic processing aid may be required. If an anionic polymer is used, a cationic processing aid is required. Examples of cationic processing aids include cationic polyacrylamides, di/tri valent cations, metal salts, epichlorohydrin-amine adducts such as Kymene®, alum, polyamines, polyethylene imine, polylysine, and other cationic polymers. Processing aids are typically required for wet-laid processes, although the amount can be almost negligible. The amount can typically range from about 0.01 to about 5%.

Optional Additional Components and/or Processes

In addition to the wood, non-wood fibers, binding agent, fillers, and the like discussed above, other additives can be used to provide specific benefits in the end use product. The following optional components can be added separately or as part of the binding agent used in wet processing. Some components can be included into the finished product during post processing, for example, coating, impregnation, saturation, molding, and the like.

Crosslinkers

Crosslinkers can be used to provide additional strength and durability. Examples include siloxanes, phenolics, melamine formaldehyde (MF) and urea formaldehyde (UF) resins, epoxies, isocyanates, ethylene imines, and metal salts.

Retention and Drainage Aids

These additives can be added to control the aggregate size of the fiber/filler flocculant formed in wet end processes. They can assist in the formation of a sheet of the engineered wood products, and also reduce the time it takes to form sheets without leaving significant residues in the water. Examples include cationic polyelectrolytes, cationic latex, cationic starch, metal salts and metal ions such as alum and the like, other cationic materials such as epicholorohydrin-amine adducts, e.g., Kymene® products from Hercules, and polyethylene imines.

Hydrophobic Agents

These additives can improve the water repellency and reduce the water absorbency characteristics of the material, either by changing the surface energy, or by filling voids in the structure. Representative examples include wax, silicones, fluorinated materials, hydrocarbon additives, oils, fats, fatty acids, and calcium stearate. Although not technically hydrophobic, glycols and other polyols, such as polyethylene glycol can also be used, since they have a low vapor pressure, and inhibit the ability of water to enter into and swell the fibers.

Coloring Agents

These additives provide coloring to the substrate. These include organic and inorganic pigments and dyes, examples of which include phthalocynanine blue, iron oxide, titanium oxide, carbon black, indigo, and the like. In some embodiments, the color of the material is provided, at least in part, by the type of wood that is used.

Dispersants/Surfactants

These additives can be added to keep the fillers and pigments wetted and well dispersed in the formulation. In wet end processing, they can also help control the formation of the sheet. Examples include carboxylate, ethoxylate and sulfonate-based materials, e.g., Tamol® L, Tamol® 731A, Morcryl® (all from Rohm and Haas).

Chelating Agents

These additives are used to chelate the metal ions in the wet end process. They also help to control the aggregate size and thereby can affect drainage and retention. Examples include EDTA and EDTA derivatives.

Coagulants/Flocculants/Drainage Aids

A coagulant/flocculant can also be added to the fiber furnish to facilitate flocculation of the particles. Suitable cationic coagulants include polyacrylamides, including those with low, medium, and high molecular weight, and low, medium, and high cationic charge, alum and/or other polymer high charge coagulants, for example, polyamines (cationic polymers), and mineral salt divalent and trivalent ions, examples of which include calcium and aluminum salts, respectively. Suitable flocculants include low, medium, or high molecular weight polyacrylamides with low, medium, or high cationic charge. To further improve the drainage of the fiber furnish, drainage aids such as colloidal silica, bentonite, or other high surface area particles may be employed.

An example of a preferred flocculant package may include a polyamine such as Alcofix 159 or Nalco 7607 or Bubond 167, with a low charge polyacrylamide such as Superfloc MX10, Bufloc 594, or Nalco 61067, and colloidal silica such as Bufloc 5461 or Eka NP780.

Cationic Wet Strength Resins

Wet strength refers to the ability of paper products to maintain a substantial proportion of their original strength after being completely saturated with water. Wet strength can be important when the engineered wood products are intended for use under wet conditions.

The wet strength of paper and wood products is primarily enhanced using reactive, polymeric chemicals such as polyamidoamine-epichlorohydrin resins, which are generally referred to as cationic wet-strength resin. Resin performance is maximized by adding them at a point in the process where the pH is within the range of about 6 to 9, mixing the additive with the furnish, and ensuring that the total charge of the furnish is sufficiently negative, so that there is not an excessive positive charge after the wet strength resin is added. Fiber refining techniques, such as those described herein, and the presence of a negative charge at the fiber surfaces, can enhance the adsorption of the wet-strength resins. Polyamidoamine-epichlorohydrin (PAAE) is one example of a cationic wet strength resin. Kymene®) resins are well known cationic wet strength resins with polyamide-epichlorohydrin (PAE) functionality.

### II. Processes for Preparing the Substrate

The process used to prepare the materials is a wet-laid process. In one embodiment, the products are prepared using a single-ply fourdrinier machine. The process is described in more detail below.

The wet laid process involves the formation of a fibrous mat or sheet from an aqueous slurry having a mixture of ingredients that contribute to strength, uniformity, and other sheet related properties important to a specific application. The ingredients in the mixture are chosen to improve processing, e.g., retention aids or some specific property of the finished sheet, such as porosity, stiffness, water repellency, etc. It is typically a batch process in which all the components are added together at one stage in the process, in a sequential manner, or certain components can be withheld and added at an appropriate point in the process to have the most desirable effect in terms of the formation of the fibrous sheet and its properties.

Typical processes that have been used for this purpose have traditionally been based on papermaking methods, and involve using a fourdrinier or cylinder machines in which the fibrous mat or sheet is formed on a preformed wire mesh, then dried and rolled into a finished rolled good. The thickness of the sheet is controlled by the amount of fiber and other ingredients in the slurry. These sheets can then be post processed using techniques such as calendaring, coating, laminating, bonding, embossing, extrusion, molding, etc., to add other layers or substrates that impart additional properties to the sheet such as strength, impermeability, styling, shape, dimensional stability, etc. The thickness can range, for example, from around a sixteenth of an inch to in excess of four inches, depending on the desired product specifications and the manner in which it is prepared. In one embodiment, a traditional medium density fiberboard (MDF) preparation process can be used in place of the fourdrinier or cylinder machines.

As described in the summary above, the wet end process involves making an aqueous slurry in which a mixture of components is dispersed. This can be done as a batch process in which all of the components are added at the same time in a mix tank or machine chest fitted with mixing capabilities or certain components may be held and added at the appropriate time and at a specified location (e.g., further downstream from the machine chest) to get the best desired results. In the batch process, one would typically start with water in the machine chest and in a sequential manner the other components can be added while mixing. Normally, this would involve the addition of fibers (e.g., wood, cellulose, cotton, etc.), fillers/pigments and dyes (e.g., talc, carbon black, etc.), binders (such as latex and/or other resins), retention and drainage aids (e.g., alum, bentonite clays, cationic polymers, etc.), wet and dry strength additives (e.g., Kymene®), and other ingredients that add specific functions to the finished product. These ingredients are known to one in the art and are used as needed to impart specific properties to the finished product, such as strength, water repellency, stiffness, etc.

Typically, the order of addition is such that the fibers and fillers are added to the water and mixed well, followed by the addition of a wet strength resin, before the addition of the binder. In most cases the binder that is used is either anionic or nonionic in character and deposited onto the fiber/filler surface by adding a cationic wet strength resin prior to binder addition to the above mixture, followed by a cationic coagulant (retention/drainage aid). This results in the formation of fiber/filler/binder flocs or aggregates. In other embodiments, when a cationic latex is used, it may be possible to avoid using the cationic wet strength resin (and an anionic flocculant would be used). The flocculant is usually the last component to be added to the process to get the final aggregation to take place. All other functional ingredients, such as pigments, crosslinkers, etc., are added prior to the addition of the flocculant. The amount of fibers, fillers, binders and the like which are added depend on the final basis weight or the thickness of the sheet that is to be made. Typically, the solids concentration of the slurry is <3-4%, and is usually decided by the sheet formation process and the desired uniformity of the sheet. These processes are well known to those in the paper making art and have some similarities with other wet laid methods used in nonwovens.

Once the binder has been flocculated using a cationic component (or an anionic component in the case of a cationic latex), the aggregates formed can be drained to remove the water and the sheet is usually formed on to a wire mesh screen. The turbidity of the water is a good indicator of whether all of the solid material has been retained on the screen. The conventional equipment that is typically used for such a wet end process involves the use of a fourdrinier or a cylinder machine. This is very well known in the paper making industry. The sheet that is formed on the wire is then typically dried over a drum drier and then rolled into sheet goods ready for shipment or post-processing. Alternatively, an article can be formed directly by depositing the aggregates onto a tool in a pulp molding or similar machine.

The binder can also be cationic in nature, unlike conventional anionic materials, and in such cases the material would have a natural affinity for the negatively-charged fibers and fillers and a cationic retention aid would not be needed. However, there may be a need in such a case to add some anionic retention aids to make sure that a substantial part of the solids are captured effectively on the screen.

In some embodiments, one can add a polyamine or additional cationic wet strength resin following the addition of the latex, to ensure that the latex is cleared from the water and placed onto the fibers.

In other embodiments, rather than using a polyamine, one can raise the pH of the mixture (for example, by adding a base such as sodium carbonate), and using alum or a similar flocculant to flocculate the fibers, filler and binder.

In an extension of the wet-end process, the forming wire screen can be made of polyolefins, polyester or other fiber materials that can become part of the sheet and can act as a scrim material that supports the fibrous sheet that has been formed. Such replaceable wire mesh screens that can become part of the formed substrate are known in the art.

The finished sheet can also go through several post processing steps such as calendering, lamination, extrusion, coating, embossing, foaming, molding, etc., to add further layers, modify the surface or attachments (e.g., scrims, plastic extrusion, foam, etc.) that provide specific benefits such as strength, dimensional stability, water repellency, etc. This can be done on-line using equipments such as size press, spray coating, calendaring, laminating, etc., or off-line such as extrusion, embossing, etc. These post- or in-process steps enhance the value and features obtained from the sheet substrate made by the wet end process.

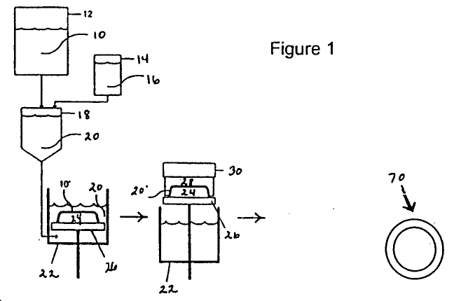

One preferred process for making the engineered wood product described herein is illustrated in FIG. 1. This process is carried out using an adaptation of a traditional fine pulp molding process in which a portion 10 of the composite materials (filler, wood and non-wood fibers, binder, optional cationic source and any additives such as colorants, antioxidants, anti-microbial agents, etc.) are mixed in a mix tank 12. The materials are mixed as a dilute mixture in water at about 1 to 10% solids based on total wet weight. The materials can be added in any order with the exception of the flocculating agent, which is preferably added last. Preferably, the majority of the water is placed in the tank, followed by the fibers, fillers, cationic source, and binder. Any other additives or fillers may then be added prior to or after flocculation occurs.

In a separate tank 14, a flocculant and/or cationic source 16 is prepared for addition and stored. While a single tank is illustrated herein, it should be appreciated that multiple tanks may be necessary to achieve the correct degree of flocculation.

The mixed materials 10 are then placed in a flocculation tank 18 and the materials are flocculated by the batch-wise addition of flocculant 16 from the tank 14. Additional water can be added at this step to decrease the material solids to between 0.1 and 5% solids based on total wet weight. The flocculated material 20 is then transferred to a formation tank 22.

The flocculation tank 18 is preferably agitated by a low shear, low efficiency agitator such as an A310 type agitator which includes several vertically fixed profiled baffles (not shown). The baffles and agitator keep the flocculated material dispersed and prevent settling without imparting a level of shear that would degrade the flocculated material structure. The baffles are designed to provide low flow resistance and axial mixing.

The batch flocculation tank 18 is operated so that a desired amount of flocculated material 20 is made periodically and sent to the formation tank 22 to keep the formation tank level above a minimum level but below a maximum level. Minimum shear is desirable during the flocculation and transfer process. Accordingly, it is preferable to transfer the flocculated material 20 from flocculation tank 18 to the formation tank 22 by means of gravity feed. This requires that the flocculation tank 18 be located physically above the formation tank 22 as shown.

In an alternative embodiment (not shown) the mixed materials may be run through one or more step tanks. Floculant is continuously added to the step tanks from storage tanks. Additional water can also be added at this time to decrease the material solids to between 0.1 and 5% solids based on total wet weight. The resulting flocculated material is then transferred to the formation tank. The step tanks are essentially equivalent in design and include low shear, low efficiency agitators such as an A310 type agitator. The mixed material enters the step tanks through ports located in the top of the tanks such that the mixed material is preferably introduced at the tip of the agitator blade. The material preferably drops down in the vessel and is processed around an interior draft tube which helps to determine the flow path and average residence time of the flocculated material. The draft tube includes low shear axial flow profiled baffles. The tanks also include profiled baffles. After the flocculated material has moved down and around the draft tube, it rises in an annular ring between the draft tube exterior wall and the tank interior wall until it reaches an overflow outlet which controls the height of the flocculated material.

The draft tube functions to minimize the average residence time of the material in the step tank while maintaining a low shear environment. However, the draft tube is not critical to the function of the step tank and may be removed in some or all of the step tanks depending on the desired flocculated particle size and its resistance to shear degradation.

This continuous system minimizes the total shear the flocculated material will receive before it is formed into an article. The rate of flocculated material production in the continuous step tank system is controlled to maintain a constant level of flocculated material in the formation tank.

In another alternative embodiment (not shown), the composite mixture can be delivered directly to a vented formation tool which is a porous shaped tool which may be covered with a screen of fine mesh on the outside. The mixture is delivered in amounts just necessary for formation of a single part. In this method, the material would be flocculated while being delivered to the formation tool by flocculant addition and in-line mixing using a device such as a static line mixer. In this method, the formation tank can be removed and the flocculated composite material shear history is held to an absolute minimum.

In the embodiment shown in FIG. 1, the flocculated material composite material 20 in the formation tank 22 is maintained at around 0.1 to 5% solids based on total wet weight. A vented formation tool 24 is then placed into the mixture. The tool 24 is a porous tool which may be covered with a screen of fine mesh on the outside. It is mounted on a platen 26 and is adapted to have a vacuum drawn through it such that it pulls water from the mixture 20 through the tool and into a vacuum system (not shown). As water is drawn through the porous formation tool, a layer of flocculated material 20′is retained. After the material 20′has built up on the tool 24 to the extent desired, the tool is removed from the mixture. The amount of material retained on the tool is dependent on the length of time the vacuum is employed, the strength of the vacuum, the concentration of the flocculated mixture, and the nature of the strength of the flocculated materials and their ability to withstand shear. Each of these variables can be independently manipulated to control deposition weight. This allows for a wide variety of control in producing acceptable articles. It is possible to continue to pull vacuum on the formation tool 24 after it has been lifted from the flocculated mixture 20 in order to decrease the water content of the formed article. A substantial portion of the water is removed by vacuum induced water drainage. By “a substantial portion”, it is meant that the solids content of the shaped article can increase from 0.1 to 5% solids based on total weight as received in the formation tank to around 40 to 70% solids or more based on total wet weight. This minimizes the energy required to complete the drying process. Heat can also be utilized through the platen 26 or tool 24 to further decrease the water content of the formed article. Although only one tool 24 is shown on platen 26, it should be appreciated that the platen may hold any number of tools that can be geometrically fitted into the available area. In a typical system, the number of tools per platen should be maximized to operate at the greatest efficiency.

After the formation tool 24 and platen 26 are removed from the formation tank 22, the tool can be mated to a vented transfer tool 28 positioned on a receiving platen 30. Once mated, vacuum can be applied to both tools 24, 28 to further decrease the water content of the formed article 20′.

Heat can also be applied through the top and bottom platens 26, 30 and/or tools 24, 28 to help drive off water and dry the article. While FIG. 1 shows a single formation and transfer tool manage for the purpose of drying, it should be appreciated that the article may be transferred by means of additional transfer tools mounted on additional platens such that the article is moved to additional vented drying tools in series. This can be done to decrease the time each article spends drying on each tool by spreading this time out over several stations, resulting in increased output. It should be apparent that the independent drying and transfer tools can be operated at different temperatures to enhance the rate at which water is removed without damaging the article by drying too rapidly or with too much heat.

The drying process results in an article having the desired shape and size. The article shown in the drawing figures is in the form of a substantially circular container 70. It should be understood that the shape of the formation, transfer and drying tools employed controls the shape of the container.

Additional steps not shown in FIG. 1 may also be incorporated into the method of forming the container. For example, the article may be pressed at any point during the formation or drying step to increase surface smoothness or to densify the material. Pressing can also be performed offline after the formation is complete, either on the dried article or on a remoistened article.

Pressing can be performed at room temperature or at elevated temperatures.

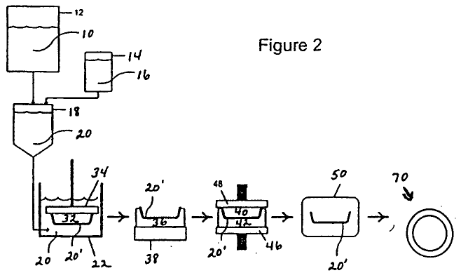

An alternative process for making the container is illustrated in FIG. 2 which utilizes an adaptation of a traditional thin wall pulp molding process. The initial process is identical to the process illustrated in FIG. 1, i.e., the composite materials 10 are mixed and placed in the tank 12, then transferred to flocculation tank 18 in which flocculant 16 is added from tank 14 to obtain flocculated material 20. (The mixed material may also be run through step tanks as described above with reference to FIG. 1).

As shown in FIG. 2, a vented formation tool 32 is placed into the flocculated material mixture 20. The tool 32 is porous and may be covered with a screen of fine mesh on the outside.

Tool 32 is mounted on a platen 34 and is adapted to have vacuum drawn through it as described above. In an alternative embodiment as described above, the composite mixture can be delivered directly to the formation tool in an amount appropriate for the formation of a single part.

After the material 20 is formed on the formation tool 32, it is transferred to a vented transfer tool 36 positioned on a second platen 38. As shown, the transfer tool is a mated match for formation tool 32 but the tools are not closed together with pressure. Vacuum is drawn through the formation and transfer tools 32, 36 and heat may be additionally employed to decrease the water content of the resulting article 20′. A substantial portion of the water is removed by vacuum induced water drainage. This minimizes the energy required to complete the drying process.

After article 20′is sufficiently dry to retain its shape, it is transferred between two pressing tools 40, 42 mounted on two separate platens 46, 48. Pressure is applied to both platens so that the tools 40, 42 are forced together. This pressing step may be followed by the final drying step. If the drying step follows pressing, the tools must be vented to allow for the evolution of steam during the pressing process. Also, to aid in the forming and drying process, the press tools and/or platens can be heated. If desired, the article 20′may be dried prior to pressing. In this case, the tools do not need to be vented.

The article 20′ may be dried in any industrial oven 50 until it reaches the desired dryness.

Suitable ovens include gas or electric forced air impingement ovens or any other type of commercially available drying oven. The process results in a shaped article, which in the embodiment shown, is in the form of a substantially circular container 70 which is appropriate for cooking at elevated temperatures.

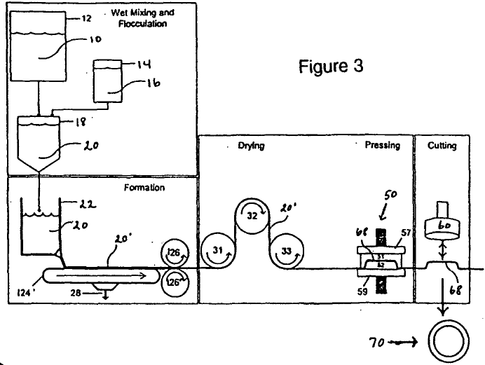

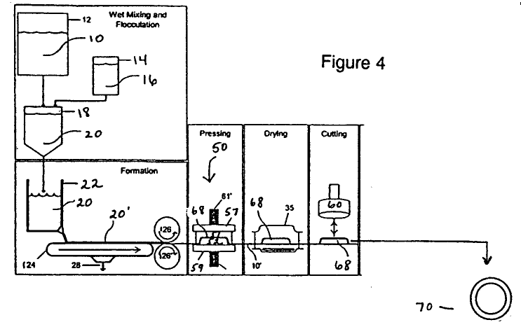

Another preferred process for making the engineered wood product of the present invention is illustrated in FIGS. 3 and 4. This process is carried out using a unique adaptation of a paper-making process.

In the paper-making and thermoforming process illustrated in FIG. 3, a portion 10 of the composite materials (filler, wood and non-wood fibers, binder, optional cationic source and hydrophobic agent, and any additives such as colorants, anti-oxidants, anti-microbial agents, etc.) are mixed in a mix tank 12. The materials are mixed as a dilute mixture in water at about 1 to 10% solids based on the total wet weight. The materials can be added in any order with the exception of the flocculating agent, which is preferably added last. Preferably, the majority of the water is placed in the tank, followed by the fibers, fillers, cationic source, and binder. Any other additives or fillers may then be added prior to or after flocculation occurs.

In a separate tank 14, a flocculant and/or cationic source 16 is prepared for addition and stored. While a single tank is illustrated herein, it should be appreciated that multiple tanks may be necessary to achieve the correct degree of flocculation.

The mixed materials 10 are placed in the flocculation tank 18 and the materials are flocculated by the batch-wise addition of flocculant 16 from tank 14. Additional water can be added at this step to decrease the material solids to between 0.1 and 5% solids based on total wet weight. The flocculated material 20 is then transferred to a formation tank 22.

The flocculation tank 18 is preferably agitated by a low shear, low efficiency agitator such as an A310 type agitator which includes several vertically fixed profiled baffles (not shown).

The batch flocculation tank 18 is operated so that a desired amount of flocculated material 20 is made periodically and sent to the formation tank 22 to keep the formation tank level above a minimum level but below a maximum level. Minimum shear is desirable during the flocculation and transfer process. Accordingly, it is preferable to transfer the flocculated material 20 from flocculation tank 18 to the formation tank 22 by means of gravity feed. This requires that the flocculation tank 18 be located physically above the formation tank 22 as shown.

In an alternative embodiment (not shown), the mixed materials 10 may be run through one or more step tanks as described above with regard to the pulp molding process. Additional water can also be added at this time to decrease the material solids to between 0.1 and 5% solids based on total wet weight. The resulting flocculated material is then transferred to the formation tank. The rate of flocculated material production in the continuous step tank system is controlled to maintain a constant level of flocculated material in the formation tank 22.

The flocculated material 20 is formed into a sheet by placing the flocculated composite mixture on a moving wire screen 124 from the formation tank 22. The material is evenly distributed over a wide screen (up to or more than 12 feet wide) by the use of a flowspreader or other similar apparatus, and water is removed from the forming sheet at 28. This apparatus is similar to a Fourdrinier paper formation system. As with a Fourdrinier system, the water is removed from the sheet by the use of appropriate placed hydrofoils, table rolls, and vacuum boxes.

Additional apparatus such as a breast roll, rubber deckle, and dandy rolls may also be used. It should be understood that any appropriate paper formation system could be used as long as it can be adapted to handle the composite material of the present invention.

During the sheet formation step, a substantial portion of water is removed from the composite material. Once it is sufficiently dry to retain its shape and allow handling, the sheet 20′is separated from the wire screen at couch roll 126′and opposing lump breaker roll 126. At this point the sheet has sufficient strength to be processed as a freestanding sheet. No mechanical assistance is required to transport the sheet other than to pull it through the finishing path along which it will travel.

At the couch roll 126′, the sheet 20′may simply be removed from the wire or it can be lightly or significantly pressed by couch roll 126′and lump breaker rolls 126 or by additional process rolls up or downstream of the couch roll. This pressing contributes to surface smoothness and densification of the sheet. As is known by those skilled in the art of papermaking, if substantial pressing is done and the composite sheet changes dimension in the thickness direction, the resulting sheet will be moving more rapidly than prior to pressing. The increase in speed should be directly related to the decrease in thickness and all other steps in the process should accommodate this rate change.

Once the sheet 20′is formed and removed from the screen 124 at couch roll 126′, it can be dried. As shown in FIG. 3, a series of three drying cylinders 31, 32, 33 are utilized for drying. It should be understood that the number of drying cylinders may vary based on the wetness of the material. The cylinders may be heated in any conventional way, such as steam and hot oil.

The composite material sheet 20′is typically in contact with the drying cylinder (s).

Optionally, a felt sheet (not shown) may be placed behind the composite material 10 to force greater contact as the sheet passes over the drying cylinders. The felt must allow for water transport so that it does not retard drying. Two felt loops can be utilized in this fashion, one for the top set of rollers and one for the bottom set of rollers.

It should also be understood that other conventional drying techniques may be used such as gas forced air ovens, electrical forced air ovens, steam forced air ovens, microwave heating, etc.

The composite sheet 20′is then preferably pressed into a geometric shape by a single mated tool press 50 that employs pressure against upper and lower platens 57, 59 which include a male tool 52 and a matched female tool 51. When the composite sheet is positioned correctly, the tools will mate and force the material into the tool shapes to form an article 68. Care must be taken not to tear the material during the pressing step. If the pressing is done too rapidly, or the size of the change exceeds the limitations of the specific formulation in use, the resulting article will be damaged. The tools may be heated to aid in formation.

It should be noted that while the pressing step is illustrated as being continuous with the other steps, it does not have to be. The composite sheet can be rolled or cut into discrete segments and pressed at a convenient time and location. It should be understood that the shape of the tools controls the shape of the resulting article.

While FIG. 3 illustrates a single tool set being used to press a single article, it should be appreciated that multiple tools could be employed to create multiple articles with each compression.

After pressing, the article 68 is preferably cut from the continuous sheet using a single cutting unit 60 to form a finished article, which in the embodiment shown, is in the form of a steering wheel 70. This unit descends onto the article 68 and cuts using any appropriate die cutting system around the perimeter of the container leaving a clean and aesthetically pleasing edge. The article 70 is removed from the scrap composite material sheet so that it can be sorted, stacked, wrapped and/or packed for shipment. It should be understood that the article can be removed by a number of techniques. The scrap composite material can be accumulated for recycling or discarded as appropriate.

An alternative method of the present invention is illustrated in FIG. 4 in which the article 68 is pressed prior to drying, i.e., the article is pressed in a moist condition. In this method, the materials are mixed and flocculated, and the flocculated mixture 20 is placed on a moving wire screen 124 as described above. The moist composite sheet 20′is removed from the wire and pressed in a tool 50 to form a shaped article 68. The article 68 is then dried in any industrial oven device 35 until it reaches the desired dryness. This can be a gas or electric forced air impingement oven or any other type of commercially available drying oven. As described above, the drying step does not have to immediately follow the pressing step. Drying can be performed after cutting and/or after barrier application if an appropriate adhesive is used. After drying, the shaped article is cut as described above.

III. Components of Laminate Materials Produced from Sheets of the Engineered Wood Product

The engineered wood product can be present in the form of a single sheet, or a plurality of sheets laminated together, depending on the desired thickness of the laminate material. The sheets can be laminated together using an adhesive, or using heat and pressure. In some embodiments, when subjected to heat and pressure, a sufficient amount of the binder is present at the top and/or bottom surfaces of the sheet to enable a plurality of sheets to be laminated together. The single sheet or laminated sheets can be provided with additional layers, depending on the desired application.

Topcoat Layers

When used in flooring applications, a topcoat such as a urethane acrylate can be applied. Such topcoat layers can improve the durability and or wearability of the material, provide UV protection, and/or provide a color to the material.

The topcoat layer can be formed from any of a variety of suitable materials, including clear or, dyed, transparent, translucent or opaque materials. Examples of materials that can form the topcoat layer include but are not limited to acrylics and polyurethanes available in a variety of forms. Representative forms include solutions, solids, and dispersions.

When the engineered wood product is to be colored, the coloring can be applied to the material itself, to one or more of the topcoat layers, or both. When applied to the substrate, a primer can be used to seal the engineered wood product, particularly if a hydrophobic material is used to form the material, and is likely to bleed out and cause overlying layers to delaminate.

The color can be applied using pigments and dyes. Examples of suitable pigments include carbon black and titanium dioxide. Suitable dyes can include but are not limited to products from the family of dyes that are basic, reactive, or acid dyes. The material can also have color imparted by the nature of the wood fibers themselves.

Cushioning Layers

If the engineered wood product is to be used for subfloors or flooring applications, a cushioning layer may be desired, as a layer on the top in the core or the bottom of the product. The cushioning layers allow the product to have properties, such as softness and resiliency. In addition to providing resiliency, the cushioning layer can provide additional functions such as enhanced acoustics, conformability and/or slip resistance. In those embodiments where the material is intended to be structural, other than flooring, a cushioning layer may not be required.

Reinforcing Layers

In some embodiments, it is desirable to apply a reinforcing layer to the product. This reinforcing layer can be present inside the sheet, if it is applied as the sheet is being formed, or it can be applied to the top and/or bottom of the resulting sheet.

The reinforcing layer can be any material that reinforces the substrate sufficiently for its desired end use. Examples include scrims, wovens, knits, non-wovens, solid sheets, films, foams, and the like. These layers can be formed from synthetic or organic fibers, fiberglass, plastics, metals such as steel, aluminum or tin, and other suitable materials. The layers can be applied using a chemical application process, or a hot melt process. The thickness and density of the reinforcing layer(s) varies depending on the nature of the end-product.

A scrim can increase the strength of the product. Suitable scrim is known in the art and available commercially, and may be a plastic material such as nylon, or may be metallic, for example, steel, aluminum or tin. Scrim may be either supplied to the process in which the composite web is formed in which case the composite web is formed in/on the scrim. In another embodiment, the scrim may be adhered to the formed composite web either just as it is formed but before drying, or to a dried composite web using an adhesive.

Adhesive Layer

An adhesive layer can be used to hold the sheet/laminated sheets to the reinforcing layer, cushioning layer, or other layers. In some embodiments, the reinforcing layer is itself an adhesive, for example, a polyolefin scrim, in which case, no adhesive is necessary. When an adhesive is necessary, the adhesives can be in the form of a sheet, a scrim, a powder, a liquid, a curable composition, and the like. When provided in liquid form, they can be applied using a variety of methods, for example, knife coating, spray coating, employing a doctor blade, and the like. The adhesives can be curable, such as urethanes, acrylates, epoxies, thermoset, thermoplastic, such as ethylene vinyl acetate (EVA), polyvinyl chloride (PVC) plastisols, and polyolefins, such as polypropylene and polyethylene, hot-melt, pressure-sensitive adhesives, and rubber cement. The adhesive formulations can be 100% solids (i.e., all of the components of the composition are UV-curable, so there are no volatile emissions), water-based, or solvent-based.

Melamine/Veneer Layers

A melamine coating can be applied to the materials, for example, when the desired use is in forming laminate countertops, laminate shelving materials, laminate materials for use in cabinetry, and other embodiments where particle board is conventionally covered with a melamine coating. Those of skill in the art understand how to apply a melamine coating to a wood product, and the same application methods apply to the engineered wood product described herein.

A veneer, for example, of a wood, metal, or other material, can be adhered to the engineered wood product described herein, for example, using a contact adhesive, a pressure sensitive adhesive, a hot-melt adhesive, and the like. Those of skill in the art understand how to adhere veneers to engineered wood products such as medium density fiberboard (MDF) and other wood products, and the same techniques can be used to adhere the veneers to the engineered wood products described herein.

In one embodiment, the engineered wood product is a substrate to which a decorative wood layer is applied, where the thickness of the wood layer can be the same as, or significantly thicker than, the veneers usually used to prepare plywood. This can be used, for example, to create laminate flooring materials with a decorative laminate on the top surface, and the engineered wood product in other layers. Because the engineered wood product is more hydrophobic than wood or conventional subflooring materials, in some embodiments, it may not be necessary to apply a water-resistant underlayment between the subfloor and the flooring material.

Unique Characteristics of the Composite Material

As discussed below in Example 8, the engineered wood product described herein can exhibit minimal structural modifications upon exposure to moisture, unlike chipboard, oriented strand board, or particleboard. The hydrophobicity of the material is an improvement over these materials (and even over natural wood). The filled nature of the material, in some embodiments, provides sound absorptive and/or fire retardant properties.

### IV. Articles of Manufacture Including the Composite Material

The engineered wood product can be used to prepare various articles of manufacture. Representative product applications include, but are not limited to, home building and/or remodeling, car interiors, furniture, plywood, laminate countertops, cabinetry (particularly when covered with a veneer layer of a desired wood), I-beams, glue-lams, flooring, underlayments, and medium and high density fiberboard. The desired use will dictate the shape of the article, the thickness of the sheet, the number of laminated sheets, and any additional layers applied to the sheet(s).

These articles of manufacture can be prepared using the engineered wood product and/or composite wood material described herein. Suitable properties needed for each of these articles of manufacture, and the various components needed in each article of manufacture are well known to those of skill in the art.

There are several conventionally known and used assay protocols for determining the properties of wood products, any of which can be used to analyze and characterize the engineered wood product and resulting composite materials. Examples include, for example, ASTM D1039 (Standard Test methods for Evaluating Properties of Wood Based Fiber and Particle Panel Materials).

The following non-limiting examples are provided to illustrate the invention as described herein, and are not intended to be limiting.

### Examples 1-5

### Preparation of Representative Engineered Wood Products

A series of five formulations of the engineered wood products described herein were prepared and tested using the following general procedures.

Water was measured out in an appropriately sized beaker to handle the remainder of the formulation components with agitation. All fibers and fillers were added (the fibers and fillers can be pre mixed) to the water under agitation with a good vortex.

A desirable amount of wet strength resin, such as Kymene 736 (Hercules) was measured out and added to the fiber stock. After 1 minute, latex, antioxidant and a hydrophobic agent such as a wax were added (these components can optionally be pre-mixed). After 1 minute, a polyamine such as Alcofix 159 (Ciba) was added. After 1 minute, polyacrylamide (Nalco 61067) was added. After 1 minute, the mixture was touched up with a variable amount of colloidal silica such as Eka NP 780 (Eka Chemicals), if needed, until clear water was observed between the flocks.

A 60 or 100 mesh screen was placed on an 8×8 in head box, filled about one quarter of the way with water. The stock was added, the box was filled to the lowest rivet with water, and the mixture was mixed (for example, with a spatula) and drained. Drain time was recorded from the first pull of the handle until the first sound of suction. Two blotter papers were placed on top of sheet, and 2 blotters were placed under the screen. The sheet and screen were placed in an unheated Hydroplair® press or equivalent the day light closed for 30 seconds with no additional pressure. The sheet was removed from the screen, while noting any propensity of the formulation to stick to the screen. Two fresh blotter papers were placed on the top and bottom of the sample, and the sheet was pressed, for example, on a Hydrolair® press, at a pressure of around 2000 gauge pressure for around 30 seconds. The sheet was placed on a 250° F. sheet dryer for around 30 minutes or until dry.

The sample was then removed, and cut into quarters. The quarters can be stacked on foil and both the top and bottom covered with foil. 3 mm shims can be placed on a 400° F. Carver® press (top and bottom at 400° F.). The foil covered sample was placed on platens, with shims optionally used to control sample thickness. Day light was closed and the sheet pressed at 20,000 gauge pressure for around 1 minute. The hot sample was carefully removed and allowed to cool. Alternatively, the Hydrolair® press with a 12″×18″ platen can be used with variable platen temperatures, pressures (gauge pressure from 0-5000 psi) and press times as noted in the examples.

The sample was then weighed and trimmed to desired size and shape. The thickness length and width of the sample can then be measured, for example, to 0.001 in.

The resulting sheet was tested for its propensity to pick up water by submerging it in water for a specified time. Following water exposure, the sample can be reweighed and the thickness, length and width can be re-measured while the material was still wet, and, optionally, again after air drying if desired.

The selection of wet strength resin, antioxidant, polyamine, hydrophobic agent, polyacrylamide, and colloidal silica can be selected from a wide variety of different products within each category in the following examples. Representative formulations are shown in Tables 1-3, which show the formulations of Examples 1-5.

TABLE 1

| | Example 1 | | Example 2 | |
|---|---|---|---|---|
| Components | Dry g | Wet g | Dry g | Wet g |
| Water | | 1406.15 | | 1395.57 |
| Regenerated Wood Fiber | 0.00 | 0.00 | 15.00 | 26.50 |
| Regenerated Wood Flour | 29.99 | 31.77 | 15.00 | 15.89 |
| Regenerated Nylon Fiber | 6.00 | 6.00 | 6.00 | 6.00 |
| Filler | 11.99 | 11.99 | 12.00 | 12.00 |
| Wet strength resin | 0.20 | 1.57 | 0.20 | 1.57 |
| DL 218 Latex | 9.00 | 18.00 | 9.00 | 18.00 |
| Hydrophobic agent | 2.64 | 8.51 | 2.62 | 8.46 |
| Polyamine | 0.15 | 6.00 | 0.15 | 6.00 |
| Polyacrylamide | 0.03 | 10.00 | 0.03 | 10.01 |
| Total | 60.00 | 1500.00 | 60.00 | 1500.00 |
| % Solids | | 4.00 | | 4.00 |
| Dry time/Temp | 18 min | 250 F. | 25 min | 250 F. |
| Sample handling to press | Formed sheet, | | Formed sheet, | |
| | dried, quartered | | dried, quartered | |
| | and stacked | | and stacked | |
| Press Temp Top/Bottom F. | 400 | 400 | 400 | 400 |
| Press gauge pressure | 20000 | | 20000 | |
| Press Time | 1 min | | 1 min | |
| Cut sample | | | | |
| Dry weight g | 11.48 | | 14.12 | |
| Dry thickness in | 0.18 | | 0.18 | |
| Dry width in | 1.34 | | 1.18 | |
| Dry length in | 4.28 | | 4.17 | |
| 15 hrs wet weight g | 15.69 | | 16.72 | |
| 15 hrs wet thickness in | 0.19 | | 0.20 | |
| 15 hrs wet width in | 1.36 | | 1.18 | |
| 15 hrs wet length in | 4.34 | | 4.21 | |
| % increase in weight | 36.72 | | 18.44 | |
| % increase in thickness | 9.89 | | 11.15 | |
| % increase in width | 1.57 | | 0.71 | |
| % increase in length | 1.40 | | 0.84 | |

TABLE 2

| | Example 3 | | Example 4 | | Example 5 | |
|---|---|---|---|---|---|---|
| Components | Dry | Wet | Dry | Wet | Dry | Wet |
| Water | | 1394.22 | | 1398.70 | | 1401.53 |
| Regenerated Wood Fiber | 13.45 | 23.77 | 11.96 | 21.13 | 8.97 | 15.85 |
| Regenerated Wood Flour | 25.41 | 26.92 | 23.92 | 25.34 | 14.95 | 15.84 |
| Regenerated Nylon Fiber | 5.98 | 5.98 | 5.98 | 5.98 | 5.98 | 5.98 |
| Regenerated Glass Fiber | 0.00 | 0.00 | 5.98 | 5.98 | 5.98 | 5.98 |
| Filler | 0.00 | 0.00 | 0.00 | 0.00 | 11.96 | 11.96 |
| Wet strength resin | 0.20 | 1.56 | 0.20 | 1.56 | 0.20 | 1.56 |
| Antioxidant | 0.22 | 0.44 | 0.22 | 0.44 | 0.22 | 0.44 |
| DL 239 Latex | 4.48 | 9.75 | 2.99 | 6.50 | 2.99 | 6.50 |
| DL 218 Latex | 8.67 | 17.34 | 7.18 | 14.35 | 7.18 | 14.35 |
| Hydrophobic agent | 1.20 | 3.86 | 1.20 | 3.86 | 1.20 | 3.86 |
| Polyamine | 0.15 | 5.98 | 0.15 | 5.98 | 0.15 | 5.98 |
| Polyacrylamide | 0.02 | 9.97 | 0.02 | 9.97 | 0.02 | 9.97 |
| Colloidal Silica | 0.20 | 0.20 | 0.20 | 0.20 | 0.20 | 0.20 |
| Total | 60.00 | 1500.00 | 60.00 | 1500.00 | 60.00 | 1500.00 |
| % Solids | | 4 | | 4 | | 4 |
| Dry time/Temp | 30 min | 250 F. | 30 min | 250 F. | 30 min | 250 F. |
| Sample handling to press | Quartered, | | Quartered, | | Quartered, | |
| | stacked and | | stacked and | | stacked and | |
| | pressed | | pressed | | pressed | |
| Press Temp Top/Bottom F. | 400 | 400 | 400 | 400 | 400 | 400 |
| Press gauge pressure | 20000 | | 20000 | | 20000 | |
| Press Time | 1 min | | 1 min | | 1 min | |
| Cut sample | | | | | | |
| Dry weight g | 9.45 | | 6.61 | | 8.01 | |
| Dry thickness in | 0.23 | | 0.16 | | 0.20 | |
| Dry width in | 0.71 | | 0.65 | | 0.64 | |
| Dry length mm | 102.00 | | 108.00 | | 101.00 | |
| 15 hrs wet weight g | 12.25 | | 7.26 | | 9.81 | |
| 15 hrs wet thickness in | 0.27 | | 0.17 | | 0.22 | |
| 15 hrs wet width in | 0.72 | | 0.66 | | 0.64 | |
| 15 hrs wet length mm | 102.50 | | 108.50 | | 102.00 | |
| % increase in weight | 29.71 | | 9.73 | | 22.48 | |
| % increase in thickness | 15.85 | | 7.68 | | 10.51 | |
| % increase in width | 1.32 | | 0.61 | | 0.94 | |
| % increase in length | 0.49 | | 0.46 | | 0.99 | |

TABLE 3

| Trial Formula | Example 6 | |
|---|---|---|
| Components | Dry | Wet |
| Water | | 90035.05 |
| Softwood (Refined) | 345.49 | 17274.65 |
| Regenerated Wood Fiber | 650.91 | 1010.73 |
| Regenerated Wood Flour | 1168.11 | 1237.41 |
| Regenerated Nylon Fiber | 335.47 | 335.47 |
| Wet strength resin | 13.82 | 1381.97 |
| DRSL 22448-00 Latex | 907.96 | 1852.97 |
| Polyamine | 28.80 | 1151.87 |
| Polyacrylamide | 2.16 | 863.73 |
| Colloidal Silica | 2.28 | 22.80 |
| Total | 3455.00 | 115166.67 |
| % Solids | | 3.00 |
| Sample handling to press | Six 9″ × 6″ | |
| | sheets added | |
| | to press | |
| Press shims (stops) | None | |
| Press Temp Top/Bottom C. | 200/200 | |
| Press gauge pressure | 4000.00 | |
| Press Time | 1.5 min press, | |
| | breath, 1.5 min | |
| | press | |
| Cut sample | | |
| Dry weight g | 37.94 | |
| Dry thickness in | 0.31 | |
| Dry width in | 2.38 | |
| Dry length in | 3.48 | |
| 71 hrs wet weight g | 42.08 | |
| 71 hrs wet thickness in | 0.34 | |
| 71 hrs wet width in | 2.40 | |
| 71 hrs wet length in | 3.50 | |
| % increase in weight | 10.93 | |
| % increase in thickness | 10.76 | |
| % increase in width | 0.90 | |
| % increase in length | 0.55 | |

### Example 6

### Additional Formulation Examples

Two additional formulations (Examples 7 and 8) were prepared following the addition order shown in Table 4. Example 8 uses regenerated Denim and Regenerated Carpet Fiber in place of the wood fibers. The use of a formulation of this material may give different properties, such as sound damping or cushioning or improvements in strength properties.

The samples were prepared by layering different combinations of these materials. It was desired to make samples that were ½ inch thick up to 1 inch thick. In order to enhance bonding of the layers in the middle of the laminate, it was decided to do the compression in stages. For example, a sample was made to be ¾″ thick by combining a total of 12 sheets of the formulation of Example 7. The process was started by taking 4 stacks of 3 sheets per stack and compressing all 4 individual stacks on the heated platens at 500 gauge pressure at the same time. After 1 minute, the 4 laminated samples were then made into two stacks and pressed and finally, the 2 remaining laminated samples were made into I stack and pressed resulting in one ¾″ sample of “wood”.

This sample was then cut into two sections and one was coated with a commercial spray applied urethane. Likewise, another sample was prepared by the multiple stack method at 1″ thick. This was done by interleaving 8 layers of the formulation of Example 7 and 7 layers of the formulation of Example 8. The initial stack configuration was 5 stacks of 3 layers each. Once these 5 layers were laminated, they were made into 1 stack of the 5 laminated layers, configured so that a wood layer was on each exposed surface.

To ensure sufficient heat was transferred to the core of the sample to facilitate lamination, the press was cycled twice. Other examples using different pressing configurations are shown below. In all of these examples, it was decided to have the wood sheets be the exposed or surface layers, however the black layer (the layer of the formulation of Example 8) could be a surface layer if so desired. In another embodiment, samples of the layered material were coated with commercial polyurethane to simulate a wood floor application.

As in previous examples, the samples were pre-weighed and measured and submerged in water. After 72 hours of water immersion, the samples were measured and allowed to air dry for 72 hours. The samples were re-measured and data recorded. In all of these examples (see Table 7), the water gain was well below that obtained by commercial samples tested previously. The change in thickness, length and width was below the commercial examples in most cases and where it was not, the values were similar.

These examples illustrate that a hydrophobic wood-like material can be made using very hydrophilic fibers and processing them as described.

TABLE 4

| Components | Dry | Wet |
|---|---|---|
| Example 7 | | |
| Water | | 90035.05 |
| Softwood (Refined) | 345.49 | 17274.65 |
| Regenerated Wood Fiber | 650.91 | 1010.73 |
| Regenerated Wood Flour | 1168.11 | 1237.41 |
| Regenerated Nylon Fiber | 335.47 | 335.47 |
| Wet strength resin | 13.82 | 1381.97 |
| DRSL 22448-00 Latex | 907.96 | 1852.97 |
| Polyamine | 28.80 | 1151.87 |
| Polyacrylamide | 2.16 | 863.73 |
| Collodial Silica | 2.28 | 22.80 |
| Total | 3455.00 | 115166.67 |
| % Solids | | 3.00 |
| Example 8 | | |
| Water | | 180234.42 |
| Regenerated Denim Fiber (Refined) | 1924.97 | 1924.97 |
| Regenerated Carpet Fiber | 574.97 | 574.97 |
| Calcium Carbonate Filler | 1724.89 | 1724.89 |
| Carbon Black Dispersion | 39.14 | 97.85 |
| Wet strength resin | 29.32 | 2932.09 |
| DRSL 22447-00 Latex | 1495.63 | 2991.26 |
| Polyamine | 48.97 | 1958.79 |
| Polyacrylamide | 6.26 | 2502.23 |
| Collodial Silica | 5.85 | 58.52 |
| Total | 5850 | 195000 |
| % Solids | | 3.00 |

| | | Urethane Coated | | Urethane Coated |
|---|---|---|---|---|
| | Laminates of | Laminates of | Laminates of | Laminates of |
| Sample Description | Example 7 | Examples 7 | Examples 7/8 | Examples 7/8 |
| Sample size | 6″ × 3″ | 6″ × 3″ | 6″ × 3″ | 6″ × 3″ |
| # of Example 7/ | 12/0 | 12/0 | 8/7 | 8/7 |
| # of Example 8 | | | | |
| Preheat temp ° C./ | 200/2 | 200/2 | 200/2 | 200/2 |
| Time min | | | | |
| Press Temp Top ° C./ | 190/190 | 190/190 | 190/190 | 190/190 |
| Bottom ° C. | | | | |
| Initial # stacks/ | 4/3 | 4/3 | 5/3 | 5/3 |
| layers per stack | | | | |
| Press gauge pressure | 500 | 500 | 500 | 500 |
| Press Time min | 1 | 1 | 1 | 1 |
| Second # stacks/ | 2/6 | 2/6 | 1/15 | 1/15 |
| layers per stack | | | | |
| Press gauge | 500 | 500 | 500 | 500 |
| pressure psi | | | | |
| Press Time min | 1 | 1 | 1 | 1 |
| Third # stacks/ | 1/12 | 1/12 | 1/15 | 1/15 |
| layers per stack | | | | |
| Press gauge | 500 | 500 | 500 | 500 |
| pressure psi | | | | |
| Press Time min | 1 | 1 | 1 | 1 |
| Comments | | Coated one | | Coated one |
| | | side with | | side with |
| | | Polyurethane | | Polyurethane |
| Dry weight g | 64.82 | 53.81 | 100.69 | 84.61 |
| Dry thickness in | 0.76 | 0.76 | 1.00 | 1.02 |
| Dry width in | 2.41 | 2.33 | 2.57 | 2.30 |
| Dry length in | 2.80 | 2.40 | 2.74 | 2.56 |
| % Change in weight | 14.86 | 18.78 | 9.32 | 13.58 |
| 72 hr water soak | | | | |
| % Change in thickness | 9.38 | 11.90 | 7.80 | 9.18 |
| 72 hr water soak | | | | |
| % Change in width | 0.70 | 1.22 | 0.40 | 0.81 |
| 72 hr water soak | | | | |
| % Change in length | 1.08 | 1.02 | 0.55 | 0.39 |
| 72 hr water soak | | | | |
| % Change in weight | 2.81 | 4.43 | 1.97 | 4.04 |
| after air re-dry | | | | |
| % Change in thickness | 4.27 | 5.64 | 4.02 | 5.05 |
| after air re-dry | | | | |
| % Change in width | 0.18 | 0.72 | 0.01 | 0.29 |
| after air re-dry | | | | |
| % Change in length | 0.30 | 0.65 | −0.05 | 0.03 |
| after air re-dry | | | | |

| | Laminates of | |
|---|---|---|
| | multiple | Laminate of |
| | sheets of | multiple |
| | Examples 7 | sheets of |
| Sample Description | and 8 | Example 7 |
| Sample size | 6″ × 3″ | 6″ × 3″ |
| # of Example 7/ | 4/8 | 12/0 |
| # of Example 8 | | |
| Preheat temp ° C./ | 200/2 | 200/2 |
| Time min | | |
| Press Temp Top ° C./ | 190/190 | 190/190 |
| Bottom ° C. | | |
| Initial # stacks/ | 4/2 | 6/2 |
| layers per stack | Example 8 | |
| Press gauge pressure | 1000 | 1000 |
| Press Time min | 1 | 1 |
| Second # stacks/ | 2/4 | 2/6 |
| layers per stack | Example 8 | |
| Press gauge | 1000 | 1000 |
| pressure psi | | |
| Press Time min | 1 | 1 |
| Third # stacks/ | 1/8 | 1/12 |
| layers per stack | Example 8 | |
| Press gauge | 1000 | 1000 |
| pressure psi | | |
| Press Time min | 1 | 1 |
| Fourth # stacks/ | 1/12 (1/2 | 1/12 |
| layers per stack | Example 7, | |
| | 1/8 Example | |
| | 7, 1/2 | |
| | Example 8) | |
| Press gauge | 1000 | 1000 |
| pressure psi | | |
| Press Time min | 1 | 1 |
| Dry weight g | 45.06 | 53.20 |
| Dry thickness in | 0.70 | 0.62 |
| Dry width in | 1.76 | 2.04 |
| Dry length in | 2.47 | 2.38 |
| % Change in weight | 10.08 | 9.40 |
| 72 hr water soak | | |
| % Change in thickness | 8.70 | 11.37 |
| 72 hr water soak | | |
| % Change in width | 0.89 | 0.72 |
| 72 hr water soak | | |
| % Change in length | 0.18 | 0.10 |
| 72 hr water soak | | |
| % Change in weight | 3.37 | 2.68 |
| after air re-dry | | |
| % Change in thickness | 2.28 | 3.95 |
| after air re-dry | | |
| % Change in width | 0.28 | 0.07 |
| after air re-dry | | |
| % Change in length | 0.26 | 0.06 |
| after air re-dry | | |

### Example 7

### Additional Formulation Examples

The following example shows the impact that the latex level has on the hydrophobic nature of the engineered wood product. Formulations 1-4 were made following the addition order shown.

Unlike the previous examples, it should be noted that no additional hydrophobic agents were added to any of the formulations shown in this example. The amount of latex added to each formulation was decreased by 5% with formulation 1 containing 15% latex and formulation 4 containing no latex. The removal of latex was offset by a corresponding increase in the Regenerated Carpet Fiber as it was felt this fiber would have the least impact on the water management properties of the resultant wood sample.

Minor adjustments were made to flocculation package in Formulations 3 and 4 in order to get the appropriate flocculant formation. The data (shown in Table 5) indicates that the addition of latex helps reduce water intrusion into the sample and retards the level of dimensional change. The data also indicates that higher levels of latex further reduce water intrusion and dimensional change. After 72 hours of water immersion, the samples were measured and allowed to air dry for 72 hours. The samples were re-measured, and it was noted that the latex containing samples continued to show a lower change in thickness. Water loss was not as complete in the samples that contained latex, likely due to the tighter structure that remained in these samples.

Table 5 shows a graphical representation of the data.

TABLE 5

| | Example 9 | | Example 10 | | Example 11 | | Example 12 | |
|---|---|---|---|---|---|---|---|---|
| Components | Dry | Wet | Dry | Wet | Dry | Wet | Dry | Wet |
| Water | | 1574.60 | | 1581.08 | | 1589.95 | | 1600.25 |
| Softwood (Refined) | 6.02 | 300.99 | 6.03 | 301.50 | 6.03 | 301.27 | 6.05 | 302.41 |
| Regenerated Wood Fiber | 15.07 | 23.41 | 15.10 | 23.45 | 15.09 | 23.43 | 15.15 | 23.52 |
| Regenerated Wood Flour | 22.88 | 24.23 | 22.91 | 24.27 | 22.90 | 24.26 | 22.99 | 24.35 |
| Regenerated Carpet Fiber | 6.02 | 6.02 | 9.05 | 9.05 | 12.23 | 12.23 | 15.48 | 15.48 |
| Wet strength resin | 0.24 | 24.08 | 0.24 | 24.12 | 0.20 | 19.96 | 0.20 | 19.98 |
| DL 218 Latex | 9.03 | 18.43 | 6.03 | 12.31 | 3.01 | 6.15 | 0.00 | 0.00 |
| Antioxidant | 0.36 | 0.72 | 0.36 | 0.72 | 0.18 | 0.36 | 0.00 | 0.00 |
| Polyamine | 0.30 | 12.08 | 0.20 | 8.02 | 0.30 | 12.00 | 0.08 | 3.00 |
| Polyacrylamide | 0.04 | 15.05 | 0.04 | 15.08 | 0.02 | 9.99 | 0.03 | 10.01 |
| Collodial Silica | 0.04 | 0.40 | 0.04 | 0.40 | 0.04 | 0.40 | 0.04 | 1.00 |
| Total | 60 | 2000 | 60 | 2000 | 60 | 2000 | 60 | 2000 |
| % Latex | 15 | | 10 | | 5 | | 0 | |
| Dry weight g | 34.15 | | 34.57 | | 33.99 | | 34.81 | |
| Dry thickness in | 0.24 | | 0.26 | | 0.27 | | 0.26 | |
| Dry width in | 2.99 | | 3.31 | | 3.27 | | 3.27 | |
| Dry length in | 3.26 | | 3.04 | | 3.05 | | 3.11 | |
| % Change in weight | 39.70 | | 51.85 | | 62.96 | | 69.40 | |
| 72 hr water soak | | | | | | | | |
| % Change in thickness | 14.23 | | 15.14 | | 18.35 | | 28.45 | |
| 72 hr water soak | | | | | | | | |
| % Change in width | 1.00 | | 0.76 | | 0.76 | | 0.89 | |
| 72 hr water soak | | | | | | | | |
| % Change in length | 0.92 | | 0.73 | | 0.91 | | 0.80 | |
| 72 hr water soak | | | | | | | | |
| % Change in weight | 6.77 | | 4.33 | | 3.04 | | 3.14 | |
| after air re-dry | | | | | | | | |
| % Change in thickness | 5.63 | | 4.05 | | 8.74 | | 15.55 | |
| after air re-dry | | | | | | | | |
| % Change in width | 0.13 | | 0.06 | | 0.07 | | 0.11 | |
| after air re-dry | | | | | | | | |
| % Change in length | 0.19 | | 0.03 | | 0.11 | | 0.03 | |
| after air re-dry | | | | | | | | |

### Example 8

### Comparative Water-Soak Testing of Representative Commercial Samples and Engineered Wood Product

A comparative study was undertaken to compare the engineered wood product described herein with commercially-available engineered wood products such as plywood, unfinished particle board, particle board finished with a white melamine skin, and particle board finished with a wood-grain skin.

The formulation used to prepare the engineered wood product is shown below in Table 6.

TABLE 6

| Formulation for | | |
|---|---|---|
| Example 13 | | |
| Components | Dry | Wet |
| Water | | 16816.61 |
| Softwood (Refined) | 159.84 | 7992.13 |
| SSI Wood Fiber | 130.91 | 203.28 |
| SSI Wood Flour | 223.94 | 237.22 |
| SSI Nylon Fiber | 63.54 | 63.54 |
| Wet Strength Resin | 4.81 | 481.13 |
| DRSL 22448-00 Latex | 210.06 | 428.69 |
| Polyamine | 6.00 | 240.02 |
| Polyacrylamide | 0.50 | 200.06 |
| Colloidal Silica | 0.40 | 4.00 |
| Total | 800.00 | 26666.67 |

The dry weight, dry thickness, dry width, and dry length were measured for all samples. The materials were soaked in water for 24 hours, and the increase in weight, thickness, length, and width was measured. The analysis was repeated at 48 hours, and again at 72 hours. The formulation of Example 13 was measured at 71 hours and is added here for reference. The results are shown in Table 7.

TABLE 7

| Commercial Wood | | 2 mm | 2 mm | 1.5 mm | |
|---|---|---|---|---|---|
| Samples - | 1.8 mm | White skin | unfinished | Wood grain skin | |
| Description | Plywood | pressed board | pressed board | pressed board | Example 13 |
| Dry weight (grams) | 57.20 | 77.71 | 49.99 | 46.70 | 37.94 |
| Dry thickness (inches) | 0.71 | 0.80 | 0.79 | 0.56 | 0.31 |
| Dry width (inches) | 1.90 | 2.01 | 1.51 | 1.79 | 2.38 |
| Dry length (inches) | 3.97 | 4.19 | 3.61 | 3.63 | 3.48 |
| % increase in weight | 36.31 | 51.57 | 46.94 | 18.16 | |
| after 24 hours | | | | | |
| % increase in thickness | 8.16 | 18.68 | 19.00 | 8.95 | |
| after 24 hours | | | | | |
| % increase in width | 1.74 | 1.74 | 1.96 | 0.97 | |
| after 24 hours | | | | | |
| % increase in length | 0.95 | 0.66 | 0.69 | 0.49 | |
| after 24 hours | | | | | |
| % increase in weight | 41.84 | 60.56 | 58.02 | 25.45 | |
| after 48 hours | | | | | |
| % increase in thickness | 9.62 | 20.23 | 22.56 | 10.56 | |
| after 48 hours | | | | | |
| % increase in width | 1.81 | 1.84 | 2.07 | 1.08 | |
| after 48 hours | | | | | |
| % increase in length | 0.91 | 0.77 | 0.82 | 0.58 | (Actual water |
| after 48 hours | | | | | soak was |
| | | | | | 71 hours) |
| % increase in weight | 47.61 | 66.01 | 66.72 | 33.00 | 10.93 |
| after 72 hours | | | | | |
| % increase in thickness | 9.95 | 22.11 | 24.16 | 11.81 | 10.76 |
| after 72 hours | | | | | |
| % increase in width | 1.84 | 1.91 | 2.31 | 1.02 | 0.90 |
| after 72 hours | | | | | |
| % increase in length | 1.07 | 0.92 | 0.96 | 0.64 | 0.55 |
| after 72 hours | | | | | |
| % increase in weight | 50.57 | 68.67 | 71.66 | 37.03 | |
| after 96 hours | | | | | |
| % increase in thickness | 10.18 | 23.90 | 25.60 | 12.05 | |
| after 96 hours | | | | | |
| % increase in width | 1.91 | 1.96 | 2.33 | 1.15 | |
| after 96 hours | | | | | |
| % increase in length | 1.05 | 0.89 | 1.00 | 0.74 | |
| after 96 hours | | | | | |

In terms of percentage (%) water pickup at 72 hours, the engineered wood product described herein was by far the best (lowest) weight gain. It was among the lowest in thickness expansion (the plywood was very slightly better) and it was the lowest in length and width expansion. Therefore, the engineered wood product described herein has the potential to replace the other tested items in building applications, particularly where water-stability is an important consideration.

### Example 7

### Evaluation of the Engineered Wood Product Under Simulated Construction Conditions

To more fully evaluate the properties of the engineered wood product described herein, a series of tests was conducted that simulate the use of the product in construction. A sample board was prepared as in Examples 1-5. The board was a ⅜″ thick laminate of three sheets of material, and measured roughly six inches by six inches.

The board was adhered to a standard two by four using Loctite yellow glue, and the board adhered strongly.

The board was adhered to a standard two by four using a brad nailer and a finish nailer, and mechanical adhesion between the board and the two by four was strong. No delamination between the three individual layers was observed, and no other types of defects were observed.

The board was also adhered to a standard two by four with a 1¾″ deck screw, with and without a pilot hole, and the mechanical adhesion was strong. As with the nailing described above, no delamination between the three individual layers was observed, and no other types of defects were observed.

A 10D galvanized nail was partially nailed through the board and into the 2×4, and pulled out to observe the board. Even this relatively large nail did not delaminate the sample, and made a clean hole in the board (apparently by compressing the material around the hole).

A pressure-sensitive adhesive-backed (PSA) cherry veneer laminate was adhered to the sample using a pressure roller. The lamination strength was acceptable, and the material did not delaminate when an effort was made to delaminate the veneer from the board.

A water-based polyurethane (Minwax® water-based polyurethane) was applied to a roughly two inch by three inch portion of the board. The urethane formed a nice film layer. A solvent-based lacquer finish was applied to a similarly sized portion of the board, and also formed a nice film layer. No delamination of the layer, or blisters or cracks, were observed. Finally, an oil finish (Minwax® Antique Oil Finish) was applied to the board, and also on the adhered cherry veneer. The board was not sanded before the application of these finishes, so both the finished and unfinished samples had a slightly rough surface (i.e., not as smooth a surface as might be obtained with finish sanding), but the finishes appeared to be satisfactory for use in a variety of applications.

In conclusion, the engineered wood product described herein holds nails and screws well, can be adhered with woodworking glue and PSA adhesives, and takes a finish from both water-based and solvent-based finishes.

In the specification, typical embodiments have been disclosed and, although specific terms are employed, they are used in a generic and descriptive sense and not for purposes of limitation. It should be clearly understood that resort can be had to various other embodiments, aspects, modifications, and equivalents to those disclosed in the claims, which, after reading the description herein, may suggest themselves to one of ordinary skill in the art without departing from the spirit of the present disclosure or the scope of these claims. The following claims are provided to ensure that the present application meets all statutory requirements as a priority application in all jurisdictions and shall not be construed as setting forth the full scope of the latex composition, methods for use of same, and articles incorporating or containing same that are disclosed herein.

1. An engineered wood product comprising:
a) wood fibers,
b) non-wood fibers selected from natural cellulosic fibers, synthetic polymers, and inorganic fibers,
c) a binding agent, and, optionally,
d) a hydrophobic agent.

2. The engineered wood product of claim 1, wherein the wood fibers comprise fibers derived from post-industrial or post-consumer waste.

3. The engineered wood product of claim 1, wherein the binding agent is a latex.

4. The engineered wood product of claim 3, wherein the polymer particles in the latex comprise a polymer selected from the group consisting of polyacrylic acid, styrene-acrylic copolymers, styrene-butadiene copolymers, nitrile-containing polymers, nitrile-butadiene copolymers, polyvinyl acetate, polyvinyl acrylic acid, and blends thereof.

5. The engineered wood product of claim 1, wherein the other cellulosic fibers comprise cellulose.

6. The engineered wood product of claim 5, wherein the cellulose fibers are cotton fibers.

7. The engineered wood product of claim 1, wherein a hydrophobic agent is present, and the hydrophobic agent is selected from the group consisting of oils, waxes, fatty acids and calcium stearate.

8. The engineered wood product of claim 1, further comprising one or more additional components, selected from the group consisting of wet strength resins, crosslinkers, antioxidants, polyamines, polyacrylamide, pigments, dyes, Bentonite clays and colloidal silica.

9. The engineered wood product of claim 1, in the form of a sheet.

10. A laminate comprising one or more sheets of the engineered wood product of claim 9.

11. The laminate of claim 10, further comprising an additional layer selected from the group consisting of a cushioning layer, a reinforcing layer, a top coat layer, a melamine layer, a wood veneer layer, a graphic layer, a sound deadening layer, and a wear layer.

12. A method for forming an engineered wood product, comprising:
a) forming a slurry from a combination of
i) wood fibers and non-wood fibers selected from the group consisting of natural cellulosic fibers, synthetic polymer fibers, and inorganic fibers;
ii) fillers and/or hydrophobic agents, if desired, and
iii) a cationic wet strength resin or polyamine,
b) adding a binder to the slurry,
c) adding a flocculating agent to the slurry,
d) flocculating the fibers,
e) calendaring the fiber furnish to remove the bulk of the water,
e) drying the resulting calendared material and forming it into a desired shape, and
f) heating the resulting shaped material under pressure to form an engineered wood product.

13. The method of claim 12, wherein the wood fibers comprise fibers derived from post-industrial or post-consumer waste.

14. The method of claim 12, wherein the binding agent is latex.

15. The method of claim 14, wherein the latex is styrene-acrylic, styrene-butadiene, or a blend thereof.

16. The method of claim 12, wherein the other cellulosic fibers comprise cellulose.

17. The method of claim 16, wherein the cellulose fibers are cotton fibers.

18. The method of claim 12, wherein a hydrophobic agent is present, and the hydrophobic agent is selected from the group consisting of oils, waxes, polyethylene glycol, fatty acids and calcium stearate.

19. The method of claim 12, further comprising one or more additional components, selected from the group consisting of wet strength resins, crosslinkers, antioxidants, polyamines, polyacrylamide, pigments, dyes, Bentonite clays and colloidal silica.

20. The method of claim 12, wherein the material is in the form of a sheet.

21. The method of claim 20, further comprising laminating a plurality of the sheets.

22. The method of claim 20, further comprising adhering an additional layer to the sheet, wherein the layer is selected from the group consisting of a cushioning layer, a reinforcing layer, a top coat layer, a melamine layer, a wood veneer layer, a graphic layer, a sound deadening layer, and a wear layer.

23. The method of claim 12, wherein the material is subjected to forming, extruding, injection molding, thermal molding or vacuum molding steps before being heated under pressure.

24. A method for forming an engineered wood product, comprising:
a) forming a slurry from a combination of
i) wood fibers and non-wood fibers selected from the group consisting of natural cellulosic fibers, synthetic polymer fibers, and inorganic fibers;
ii) fillers and/or hydrophobic agents, if desired,
b) adding a cationic latex to the slurry,
c) adding an anionic flocculating agent to the slurry,
d) flocculating the fibers,
e) calendaring the fiber furnish to remove the bulk of the water,
e) drying the resulting calendared material and forming it into a desired shape, and
f) heating the resulting shaped material under pressure to form an engineered wood product.

25. The method of claim 24, wherein the wood fibers comprise fibers derived from post-industrial or post-consumer waste.

26. The method of claim 24, wherein the binding agent is latex.

27. The method of claim 26, wherein the latex is styrene-acrylic, styrene-butadiene or a blend thereof.

28. The method of claim 24, wherein the other cellulosic fibers comprise cellulose.

29. The method of claim 28, wherein the cellulose fibers are cotton fibers.

30. The method of claim 24, wherein a hydrophobic agent is present, and the hydrophobic agent is selected from the group consisting of oils, waxes, polyethylene glycol, fatty acids and calcium stearate.

31. The method of claim 24, further comprising one or more additional components, selected from the group consisting of wet strength resins, crosslinkers, antioxidants, polyamines, polyacrylamide, pigments, dyes, Bentonite clays and colloidal silica.

32. The method of claim 24, wherein the material is in the form of a sheet.

33. The method of claim 32, further comprising laminating a plurality of the sheets.

34. The method of claim 33, further comprising adhering an additional layer to the sheet, wherein the layer is selected from the group consisting of a cushioning layer, a reinforcing layer, a top coat layer, a melamine layer, a wood veneer layer, a graphic layer, a sound deadening layer, and a wear layer.

35. The method of claim 24, wherein the material is subjected to forming, extruding, injection molding, thermal molding or vacuum molding steps before being heated under pressure.

36. A method for forming an engineered wood product, comprising:
a) forming a slurry from a combination of
i) wood fibers and non-wood fibers selected from the group consisting of natural cellulosic fibers, synthetic polymer fibers, and inorganic fibers;
ii) fillers and/or hydrophobic agents, if desired, and
iii) a cationic wet strength resin or polyamine,
b) adding a binder to the slurry,
c) adding a flocculating agent to the slurry,
d) flocculating the fibers,
e) dewatering the fibers on a 3 dimensional screened tool,
e) drying the resulting material in the desired shape, and optionally
f) heating the resulting shaped material under pressure to form an engineered wood product.

37. The method of claim 36, wherein the wood fibers comprise fibers derived from post-industrial or post-consumer waste.

38. The method of claim 36, wherein the binding agent is latex.

39. The method of claim 38, wherein the latex is styrene-acrylic, styrene-butadiene, or a blend thereof.

40. The method of claim 36, wherein the other cellulosic fibers comprise cellulose.

41. The method of claim 40, wherein the cellulose fibers are cotton fibers.

42. The method of claim 36, wherein a hydrophobic agent is present, and the hydrophobic agent is selected from the group consisting of oils, waxes, polyethylene glycol, fatty acids and calcium stearate.

43. The method of claim 36, further comprising one or more additional components, selected from the group consisting of wet strength resins, crosslinkers, antioxidants, polyamines, polyacrylamide, pigments, dyes, Bentonite clays and colloidal silica.

44. The method of claim 36, wherein the material is in the form of an article.

45. The method of claim 44, further comprising laminating a plurality of the articles.

46. The method of claim 44, further comprising adhering an additional layer to the article, wherein the layer is selected from the group consisting of a cushioning layer, a reinforcing layer, a top coat layer, a melamine layer, a wood veneer layer, a graphic layer, a sound deadening layer, and a wear layer.

47. The method of claim 36, wherein the material is subjected to forming, extruding, injection molding, thermal molding or vacuum molding steps before being heated under pressure.
